(19) United States
(12) Patent Application Publication
(10) Pub. No.: US 2015/0173388 A1
(43) Pub. Date: Jun. 25, 2015

(54) FAT AND/OR OIL COMPOSITION FOR HEAT COOKING AND METHOD OF PREPARING SAME

(71) Applicant: The Nisshin Oillio Group, Ltd., Tokyo (JP)

(72) Inventors: Yoshihiro MURANO, Kamakura-shi (JP); Kanji AOYAGI, Yokohama-shi (JP); Reiko EJIRI, Yokohama-shi (JP); Chee Keat YONG, Yokohama-shi (JP)

(21) Appl. No.: 14/572,078

(22) Filed: Dec. 16, 2014

(30) Foreign Application Priority Data
Dec. 24, 2013 (JP) 2013-265328

(51) Int. Cl. A23D 9/013

(52) U.S. Cl. CPC A23D 9/013

(57) ABSTRACT

Provided is a fat and/or oil composition for heat cooking containing: a fat and/or oil; and 0.02 to 0.08% by mass of an emulsifying agent. The emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid. A method of preparing such a fat and/or oil composition for heat cooking includes the steps of: refining a fat and/or oil; and adding 0.02 to 0.08% by mass of an emulsifying agent into the refined fat and/or oil.

### TECHNICAL FIELD

The present invention relates to a fat and/or oil composition for heat cooking and also relates to a method of preparing a fat and/or oil composition for heat cooking.

### BACKGROUND

In recent years, an increasing number of health-oriented consumers have driven a demand for low fat foods. Patent Literature 1, for example, discloses a fat and/or oil composition for stir-frying that allows a reduction in the amount of oil absorbed in a cooked object during frying and that provides a satisfactory taste and flavor.

Fried foods, such as fries, tempura, and fried chicken called karaage, which include batter coatings, tend to absorb more oil than stir-fried objects, and they need a more efficient reduction in the amount of absorbed oil while maintaining a satisfactory taste and flavor.

### CITATION LIST

### Patent Literature

Patent Literature 1: Japanese Patent Application Publication No. 2005-218380

### SUMMARY OF INVENTION

### Technical Problem

In view of the above, an objective of the present invention is to provide a fat and/or oil composition for heat cooking that is capable of reducing oil remaining in a cooked object after heat cooking and that is also capable of providing a satisfactory taste and flavor, and to provide a method of manufacturing such a fat and/or oil composition for heat cooking.

### Solution to Problem

One aspect of the present invention resides in the following fat and/or oil composition for heat cooking.

(1) A fat and/or oil composition for heat cooking containing: a fat and/or oil; and 0.02 to 0.08% by mass of an emulsifying agent, wherein the emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.
(2) The fat and/or oil composition for heat cooking described in the item (1), wherein the sucrose erucic acid ester preferably has a HLB value in the range from 1.5 to 3.0.

Another aspect of the present invention resides in the following method of preparing a fat and/or oil composition for heat cooking.

(1) A method of preparing a fat and/or oil composition for heat cooking including the steps of: refining a fat and/or oil; and adding 0.02 to 0.08% by mass of an emulsifying agent into the refined fat and/or oil, wherein the emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.

### Advantageous Effects of Invention

The fat and/or oil composition for heat cooking and the method of preparing a fat and/or oil composition for heat cooking according to the present invention, both of which use a predetermined emulsifying agent, can reduce oil remaining in a cooked object more efficiently for a smaller amount of the emulsifying agent compared with those according to prior art. The smaller amount of the emulsifying agent also can lead to a lower preparation cost and provide a cooked object with a good taste and flavor close to an orignal one of the fat and/or oil.

With the above advantageous effects, the fat and/or oil composition for heat cooking according to the present invention is suitably used as a frying oil for fried foods, preferably such as tempura, karaage and the like. The fat and/or oil composition for heat cooking according to the present invention is also suited for use in stir-fried foods.

### BRIEF DESCRIPTION OF DRAWINGS

The present invention will be further described below with reference to the accompanying drawings, wherein:

FIG. 1 is a graph illustrating a relation between the amount of an emulsifying agent added in a fat and/or oil composition for heat cooking and the amount of oil contained in a tempura batter cooked with the fat and/or oil composition.

FIG. 2 is a graph illustrating a relation between the amount of an emulsifying agent added in a fat and/or oil composition for heat cooking and the ratio of oil contained in a tempura batter cooked with the fat and/or oil composition.

### DESCRIPTION OF EMBODIMENTS

(1) A fat and/or oil composition for heat cooking according to the present invention contains: a fat and/or oil; and 0.02 to 0.08% by mass of an emulsifying agent, wherein the emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.

Methods for reducing oil contained in a fried food such as tempura include (1) making a thin batter to reduce the amount of the batter coating, which tends to absorb oil, (2) preventing a batter portion from absorbing oil, (3) preventing an ingredient from absorbing oil, (4) letting oil drain out (i.e., draining excess oil after frying), and the like. Since a fried food such as tempura often contains more oil in the batter portion than in the fried ingredient (the battered ingredient), the method (2) of preventing a batter portion from absorbing oil will most effectively reduce oil contained in a cooked food among the above methods.

The present inventors have repeated earnest studies to obtain a fat and/or oil composition that may not be easily absorbed through the batter portion of a fried food and that may drain well, and the present inventors have found the following, thus achieving the present invention.

As has been known from, for example, Patent Literature 1, adding an emulsifying agent into a fat and/or oil composition reduces the amount of oil contained in a cooked object (a cooked food). Although an increase in the amount of the emulsifying agent added would theoretically enhance the effect of reducing the amount of oil absorbed, adding a large amount of the emulsifying agent means an increase in a row material cost and deterioration in the original taste and flavor of the oil, and this is unrealistic. The present inventors have found that, when the amount of a certain kind of emulsifying agent added into a fat and/or oil ingredient is in the range from 0.02 to 0.08% by mass, the amount of oil absorbed in the cooked object during fry cooking is minimized. The present invention has been conceived on the basis of the above finding and provides a fat and/or oil composition for heat cooking that is capable of efficiently preventing a cooked food from absorbing oil by adding a small amount of the emulsifying agent.

<Fat and/or Oil Composition for Heat Cooking>

A fat and/or oil composition for heat cooking according to the present invention will be described below on a basis of components.

1. Fat and/or Oil

A fat and/or oil composition for heat cooking according to the present invention is prepared by using a typical fat and/or oil for heat cooking as a main component. Such a typical fat and/or oil for heat cooking may include an animal fat and/or a vegetable oil, and a hydrogenated oil, a fractionated oil, and a transesterified oil of the animal fat and/or the vegetable oil. These oils may be used alone or in a combination. Examples of the animal fat and/or the vegetable oil include a soybean oil, a rapeseed oil, a high oleic rapeseed oil, a sunflower oil, a high oleic sunflower oil, an olive oil, a safflower oil, a high oleic safflower oil, a corn oil, a cotton seed oil, a rice bran oil, beef tallow, a milk fat, a fish oil, a coconut oil, a palm oil, a palm kernel oil, and the like. Fats and/or oils that are in a liquid state at the temperature of 20° C. are preferable, because those solidifying at a room temperature need to be liquefied by heating for use. Material fats and/or oils that are in a solid state at the temperature of 20° C. and that generally turn to a liquid state when used together with another material fat and/or oil may also be preferable. Particularly, a canola oil, which has an advantage of being a liquid oil having a low melting point and excellent oxidative stability, is preferably used.

The aforementioned typical fat and/or oil preferably constitutes the entire fat and/or oil composition for heat cooking according to the present invention, except for a part of the fat and/or oil composition including an emulsifying agent and other additives that are added as needed.

2. Emulsifying Agent

Emulsifying agents function as follows in cooking of fried foods such as tempura. In cooking of, for example, tempura, an ingredient coated with a batter (a mixture of tempura flour and water) is heated in a high temperature oil (in the range from 160 to 200° C.). When the batter contacts the high temperature oil, water on a contact surface with the oil rapidly evaporates and disappears from the batter, and a flour-based solid content of the batter is baked. This phenomenon is repeated until more and more water is gradually removed from the batter to form a net structured batter including pores and baked tempura flour hard. Emulsifying agents affect a surface tension between gas and a liquid or between two liquids. Some emulsifying agents change a surface tension between “oil and a solid”, between “oil and water”, or between “oil and gas (water vapor)”, thereby causing a change in properties (a shape, a component, and a physical property) of the batter.

In a variety of emulsifying agents, those that may be selectively added to the fat and/or oil composition for heat cooking according to the present invention are a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid. The above emulsifying agent components may be used alone or in a combination. As the emulsifying agent components, commercially available food additives may be used as appropriate. Examples of the glyceryl monooleate succinate include “Sunsoft 683CB” (manufactured by Taiyo Kagaku Co., Ltd.), examples of the glyceryl monooleate citrate include “Sunsoft Plus F” (manufactured by Taiyo Kagaku Co., Ltd.), examples of the polyoxyethylene sorbitan monooleate include “EMASOL O-120V” (manufactured by Kao Corporation), examples of the sucrose erucic acid ester include “Ryoto Sugar Ester ER-290” (manufactured by Mitsubishi-Kagaku Foods Corporation), and examples of the fatty acid monoglyceride in which the constituent fatty acid contains 47% by mass or more of a polyunsaturated fatty acid include “Emulsy MO(M)” (manufactured by Riken Vitamin Co., Ltd., with a fatty acid composition by mass ratio including 24% of a palmitic acid, 21% of an oleic acid, 49% of a linoleic acid, and 6% of other acids).

The amount of the emulsifying agent to be added is in the range from 0.02 to 0.08% by mass, preferably from 0.03 to 0.07% by mass, and more preferably from 0.04 to 0.07% by mass based on the total amount of the fat and/or oil composition for heat cooking according to the present invention. As described later, the emulsifying agent of the present invention, which is added to the fat and/or oil composition for heat cooking in the amount of 0.02 to 0.08% by mass, minimizes the amount of oil absorbed in a cooked object resulting from heat cooking.

The sucrose erucic acid ester, which may be used as the emulsifying agent, has a HLB value preferably from 1.5 to 3.0, and more preferably from 1.8 to 2.5. A sucrose erucic acid ester having a HLB value of less than 1.5 might not be able to achieve the objective of the present invention, that is to say, to reduce the amount of oil absorbed in a heat-cooked food. On the other hand, a sucrose erucic acid ester having a HLB of greater than 3.0 might pose a problem that the sucrose erucic acid ester does not readily solve in the fat and/or the oil.

In the fatty acid monoglyceride in which the constituent fatty acid contains 47% by mass or more of a polyunsaturated fatty acid, the ratio of the unsaturated fatty acid in the constituent fatty acid is preferably 66% by mass or more. Examples of the unsaturated fatty acid include an oleic acid, a linoleic acid, and a linolenic acid. An oleic acid and a linoleic acid are particularly preferable. Furthermore, the ratio of a saturated fatty acid in the constituent fatty acid is preferably 30% by mass or less, and more preferably from 10 to 30% by mass. As the saturated fatty acid, a palmitic acid is preferably used. Use of such a fatty acid monoglyceride that is largely composed of an unsaturated fatty acid, preferably, a polyunsaturated fatty acid, ensures the effect of reducing the amount of oil absorbed in the cooked object.

3. Other Components

Other components, in such amounts that do not ruin the advantageous effect of the present invention, may also be added to the fat and/or oil composition for heat cooking. Such components include those used in typical fats and/or oils (such as food additives). Examples of these components include an anti-oxidizing agent, a crystal regulator, a food texture improving agent, and other emulsifying agent. These components are preferably added sometime after deodorization and before packing.

Examples of the anti-oxidizing agent include tocopherols, ascorbic acids, a flavone derivative, a kojic acid, a gallic acid derivative, a catechin and an ester thereof, a fukiic acid, a gossypol, a sesamol, and terpenes. Examples of a coloring component include a carotene and an astaxanthin. As examples of the other emulsifying agent that do not adversely affect the effect of reducing the amount of oil absorbed, any of a sucrose fatty acid ester, a sorbitan fatty acid ester, a polysorbate, a propylene glycol fatty acid ester, a polyglycerin condensed ricinoleate, diacylglycerol, waxes, sterol esters, and a phospholipid may be selected as appropriate.

<Method of Preparing Fat and/or Oil Composition for Heat Cooking>

The fat and/or oil used in a fat and/or oil composition for heat cooking according to the present invention is prepared by using, as a starting material, a raw oil extracted from a plant seed, a fruit, or an animal material, similarly to a typical fat and/or oil. The preparation of the fat and/or oil includes refining process wherein the starting material is subjected to, if necessary, a degumming step, a deoxidization step, a decolorizing step, a dewaxing step, a deodorization step is, in the stated order. This completes the preparation of the refined fat and/or oil. The degumming step, the deoxidization step, and the dewaxing step may be appropriately adopted in accordance with the quality of the raw oil that may vary according to a fat and/or oil material from which the raw oil is extracted.

A method of preparing the fat and/or oil composition for heat cooking according to the present invention includes the step of adding, into a refined fat and/or oil prepared as described above, the emulsifying agent in the amount in the aforementioned range. The emulsifying agent is preferably added and dissolved into the fat and/or oil that has undergone the refining process. The method of preparing the fat and/or oil composition for heat cooking according to the present invention may also include the step of adding other additives, as needed. The step of adding the other additives is preferably performed after the fat and/or oil has undergone the refining process, and conditions such as the fat and/or oil temperature during the adding step may be appropriately selected depending on what additives are used and why the additives are added.

The method of preparing a fat and/or oil composition for heat cooking according to the present invention provides the fat and/or oil composition for heat cooking that reduces oil remaining in a cooked object more efficiently for a smaller amount of the emulsifying agent compared with those according to prior art.

### EXAMPLES

Hereinafter, the present invention will be described in detail based on Examples, and the present invention is not limited to these Examples.

### <Test 1: Test to Measure Amount of Oil in Tempura Batter>

A measurement test was conducted with use of a model test system in which tempura batters only, without the ingredients to be fried, were cooked. The tempura batters were cooked with fat and/or oil compositions for heat cooking that were prepared by adding a variety of emulsifying agents. The amounts of oil remaining in the cooked batters were measured. The preparation and the measurement included the following processes.

1. Preparation of Samples

A variety of emulsifying agents No. 1 to No. 11 shown in Table 1 were each mixed into a refined rapeseed oil named “Nisshin canola oil” (manufactured by Nisshin Oillio Group, Ltd.) to constitute 0% by mass (indicating no addition of the emulsifying agent), 0.05% by mass, 0.1% by mass, and 0.25% by mass in the resulting mixtures. Thus, the corresponding variety of fat and/or oil compositions for heat cooking (herein after, frying oils) were prepared. The predetermined amounts of each emulsifying agent were separately added and dissolved in 800 g of the canola oil that has been heated to a temperature of 180° C.

A batter was prepared by mixing 38 g of tempura flour named “Showa tempura flour” (manufactured by Showa Sangyo Co., Ltd.) with 62 g of iced water.

The prepared batter was divided into portions in iron cup containers, each portion having a weight of 3.5 g. Then, 5 batter portions, together with the cup containers, were dropped at a time into each of the prepared frying oils that has been heated to 180° C. in an iron pot, and were heated for 3 minutes. The dropped batter portions separate from the corresponding cup containers and float to form the batters, and the iron cup containers settle. After an elapse of 1.5 minutes, the batters were turned over, and after 3 minutes from then, the cooked batters were placed on a draining rack and left to stand for 5 minutes to drain oil. Thus, batter samples for measurement were prepared.

The number of the batters used for each frying oil was 10.

2. Measurement of Amount of Oil

The prepared samples (heat cooked batters) for measurement were subjected to weight measurement, followed by drying under a reduced pressure to remove water therefrom. At that time, the weights of the samples were measured before and after the samples were subjected to the drying in order to calculate the amounts of water contained therein.

Each of the dried samples was immersed in hexane to let the oil contained in the sample dissolve in a hexane fraction (oil extraction). The hexane fraction was collected to remove the hexane. Subsequently, the remaining oil was weighed. An average of the weight values obtained from 10 samples was calculated as the amount of oil. Furthermore, the ratio of oil was calculated by dividing the weights of the oils by the weights of the samples which have not yet been subjected to the drying. Table 1 lists the amount of oil and the ratio of oil for the samples using the frying oils.

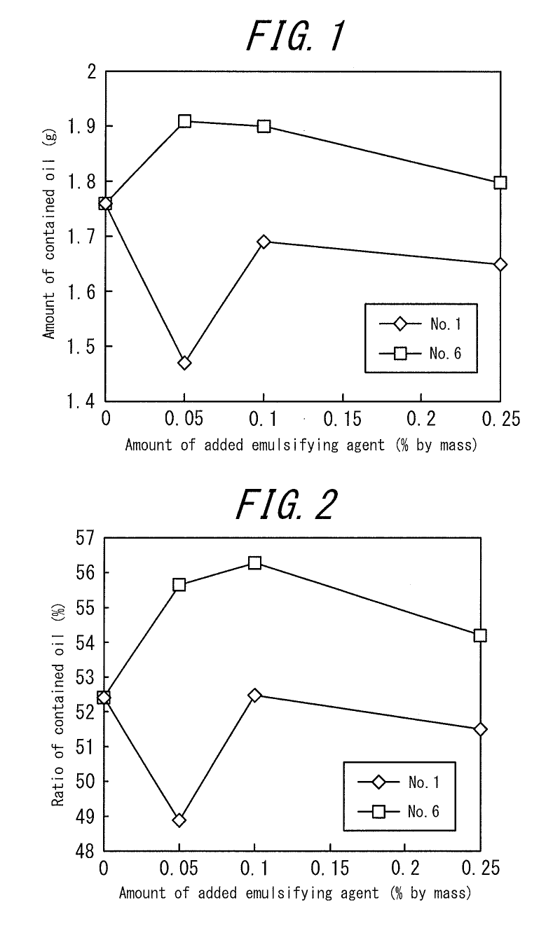

For the respective frying oils with the emulsifying agents No. 1 and No. 6, a relation between the amount of the emulsifying agent added to the fat and/or oil and the amount of oil contained in the samples is shown in a graph of FIG. 1, and a relation between the amount of the emulsifying agent added to the fat and/or oil and the ratio of oil contained in the samples is shown in a graph of FIG. 2.

TABLE 1

| Emulsifying agent | | Amount of oil (g) | | | | Ratio of oil (%) | | | |
|---|---|---|---|---|---|---|---|---|---|
| | Added amount | No | | | | No | | | |
| | (% by mass) | addi- | | | | addi- | | | |
| No. | Type | tion | 0.050 | 0.10 | 0.25 | tion | 0.050 | 0.10 | 0.25 |
| 1 | Glyceryl monooleate | 1.76 | 1.47 | 1.69 | 1.65 | 52.4 | 48.9 | 52.5 | 51.5 |
| | succinate^{*1} | | | | | | | | |
| 2 | Glyceryl monooleate | 1.76 | 1.53 | 1.79 | 1.88 | 52.4 | 47.3 | 54.8 | 58.3 |
| | citrate^{*2} | | | | | | | | |
| 3 | Polyoxyethylene sorbitan | 1.76 | 1.41 | 1.53 | 1.67 | 52.4 | 49.2 | 52.8 | 56.4 |
| | monooleate^{*3} | | | | | | | | |
| 4 | Sucrose erucic acid ester^{*4} | 1.76 | 1.38 | 1.61 | 1.71 | 52.4 | 46.3 | 52.2 | 55.6 |
| 5 | Fatty acid monoglyceride^{*5} | 1.76 | 1.45 | 1.66 | 1.79 | 52.4 | 46.0 | 51.5 | 54.2 |
| 6 | Monoglycerol stearate | 1.76 | 1.91 | 1.90 | 1.80 | 52.4 | 55.7 | 56.3 | 54.2 |
| | lactate^{*6} | | | | | | | | |
| 7 | Monoglycerol laurate^{*7} | 1.76 | 1.68 | 1.77 | 1.65 | 52.4 | 53.3 | 54.6 | 52.8 |
| 8 | Polyoxyethylene sorbitan | 1.76 | 1.79 | 1.65 | 1.84 | 52.4 | 55.3 | 51.3 | 57.3 |
| | monolaurate^{*8} | | | | | | | | |
| 9 | Sucrose lauric acid ester^{*9} | 1.76 | 1.64 | 1.74 | 1.75 | 52.4 | 51.9 | 53.7 | 54.7 |
| 10 | Decaglycerol Octaerucate^{*10} | 1.76 | 1.69 | 1.66 | 1.70 | 52.4 | 53.0 | 53.3 | 53.4 |
| 11 | Fatty acid monoglyceride^{*11} | 1.76 | 1.77 | — | — | 52.4 | 53.6 | — | — |

^{*1}Trade name “Sunsoft 683CB” manufactured by Taiyo Kagaku Co., Ltd. (with a HLB value of 8.5)
^{*2}Trade name “Sunsoft Plus F” manufactured by Taiyo Kagaku Co., Ltd. (with a HLB value of 7)
^{*3}Trade name “EMASOL O-120 V” manufactured by Kao Corporation (with a HLB value of 15.0)
^{*4}Trade name “Ryoto Sugar Ester ER-290” manufactured by Mitsubishi-Kagaku Foods Corporation (with a HLB value of 2.0)
^{*5}Trade name “Emulsy MO(M)” manufactured by Riken Vitamin Co., Ltd. (with a HLB value of 4.3, and with a fatty acid composition by mass ratio including 24% of the palmitic acid, 21% of the oleic acid, 49% of the linoleic acid, and 6% of other acids)
^{*6}Trade name “Sunsoft 661AS” manufactured by Taiyo Kagaku Co., Ltd. (with a HLB value of 7.5)
^{*7}Trade name “Sunsoft No. 750” manufactured by Taiyo Kagaku Co., Ltd. (with a HLB value of 5.3)
^{*8}Trade name “EMASOL L-120 V” manufactured by Kao Corporation (with a HLB value of 16.7)
^{*9}Trade name “Ryoto Sugar Ester L-195” manufactured by Mitsubishi-Kagaku Foods Corporation (with a HLB value of 1.0)
^{*10}Trade name “SY Glyster OE-750” manufactured by Sakamoto Yakuhin Kogyo Co., Ltd. (with a HLB value of 3.7)
^{*11}Trade name “Emulsy MO” manufactured by Riken Vitamin Co., Ltd. (with a HLB value of 4.3, and with a fatty acid composition by mass ratio including 34% of the palmitic acid, 16% of the oleic acid, 45% of the linoleic acid, and 5% of other acids)

3. Analysis of Measurement Result

As shown in FIG. 1 and Table 1, the fat and/or oil composition for heat cooking in which the emulsifying agent No. 1, i.e., the glyceryl monooleate succinate, is added in the amount of approximately 0.05% by mass has been found to distinctly minimize the amount and the ratio of the oil contained in the resulting samples (tempura batters). The result shown in Table 1 also indicates the same tendency for the emulsifying agents No. 2 to No. 5. In contrast, the fat and/or oil composition for heat cooking in which the emulsifying agent No. 6, i.e., the monoglycerol stearate lactate, is added does not exhibit a minimize value of the amount of the oil within the measuring range. Similarly, the emulsifying agents No. 7 to No. 11 do not distinctly exhibit a minimize value of the amount and the ratio of the oil within the measuring range.

The above result has revealed that the emulsifying agents No. 1 to No. 5, i.e., the glyceryl monooleate succinate, the glyceryl monooleate citrate, the polyoxyethylene sorbitan monooleate, the sucrose erucic acid ester, and the fatty acid monoglyceride in which the constituent fatty acid contains 47% by mass or more of a polyunsaturated fatty acid, when added in the amount of approximately 0.05% by mass based on the total amount of the fat and/or oil composition for heat cooking, effectively reduce the amount of oil absorbed in the fried foods such as tempura.

### <Test 2: Effect Verification Test on Tempura>

Fat and/or oil compositions for heat cooking each including 0.05% by mass of a different one of the emulsifying agents No. 1 to No. 5 were prepared. With the prepared fat and/or oil compositions, tempura was actually cooked to confirm the effect of reducing the amounts of the oils contained in the cooked foods.

### 1. Preparation of Samples

A variety of emulsifying agents No. 1 to 5 shown in Table 2 were each mixed into the refined rapeseed oil named “Nisshin canola oil” (manufactured by Nisshin Oillio Group, Ltd.) to constitute 0.05% by mass in the resulting mixtures. Thus, the corresponding variety of fat and/or oil compositions for heat cooking (herein after, frying oils) were prepared. The 0.05% by mass of each emulsifying agent was added and dissolved in 800 g of the canola oil that has been heated to a temperature of 180° C. On the other hand, a canola oil with no addition of an emulsifying agent was prepared as Comparative Example 1.

A sweet potato was cut into cylindrical pieces each having a thickness of 5 mm and a diameter of 3.4 cm to form ingredients. A batter was prepared by mixing 38 g of tempura flour named “Showa tempura flour” (manufactured by Showa Sangyo Co., Ltd.) with 62 g of iced water. The sweet potato pieces were dipped into the prepared batter to be coated with the batter.

Then, the battered sweet potato pieces, 5 pieces at a time, were dropped into each of the frying oils that has been heated to 180° C. in a pot, and were heat-cooked for 3 minutes. At that time, after 1.5 minutes from the start of the heat cooking, the sweet potato pieces in the frying oils were turned over once. After the 3 minutes of heat cooking, the fried foods were placed on a draining rack to drain oil and left for 5 minutes, and then, the fried foods were collected as measurement samples.

The number of the fried food samples used for each frying oil was 10.

### 2. Measurement of Amount of Oil

The prepared measurement samples (the fried foods) were subjected to weight measurement, followed by drying under a reduced pressure to remove water therefrom. At that time, the weights of the samples were measured before and after the samples were subjected to the drying in order to calculate the amounts of water contained therein.

Each of the dried samples was immersed in 30 mL of hexane to let the oil contained in the sample dissolve in a hexane fraction (oil extraction). The hexane fraction was collected to remove the hexane. Subsequently, the remaining oil was weighed. An average of the weight values obtained from 10 samples was calculated as the amount of oil. Furthermore, the ratio of oil was calculated by dividing the weights of the oils by the weights of the samples which have not yet been subjected to the drying. Table 2 lists the amount of oil and the ratio of oil for the samples using the frying oils.

TABLE 2

| | | | Added | Amount | Ratio |
|---|---|---|---|---|---|
| | Emulsifying agent | | amount | of oil | of oil |
| | No. | Type | (% by mass) | (g) | (%) |
| Comparative | — | No addition | 0 | 2.30 | 23.8 |
| Example 1 | | | | | |
| Example 1 | 1 | Glyceryl mono- | 0.050 | 1.85 | 21.5 |
| | | oleate succinate*¹² | | | |
| Example 2 | 2 | Glyceryl mono- | 0.050 | 1.95 | 22.0 |
| | | oleate citrate*¹³ | | | |
| Example 3 | 3 | Polyoxyethylene | 0.050 | 1.73 | 21.4 |
| | | sorbitan mono- | | | |
| | | oleate*¹⁴ | | | |
| Example 4 | 4 | Sucrose erucic | 0.050 | 1.80 | 21.6 |
| | | acid ester*¹⁵ | | | |
| Example 5 | 5 | Fatty acid mono- | 0.050 | 1.82 | 21.9 |
| | | glyceride*¹⁶ | | | |

*¹²Trade name “Sunsoft 683CB” manufactured by Taiyo Kagaku Co., Ltd. (with a HLB value of 8.5)
*¹³Trade name “Sunsoft Plus F” manufactured by Taiyo Kagaku Co., Ltd. (with a HLB value of 7)
*¹⁴Trade name “EMASOL O-120V” manufactured by Kao Corporation (with a HLB value of 15.0)
*¹⁵Trade name “Ryoto Sugar Ester ER-290” manufactured by Mitsubishi-Kagaku Foods Corporation (with a HLB value of 2.0)
*¹⁶Trade name “Emulsy MO(M)” manufactured by Riken Vitamin Co., Ltd. (with a HLB value of 4.3, and fatty acid composition by mass ratio including 24% of the palmitic acid, 21% of the oleic acid, 49% of the linoleic acid, and 6% of other acids)

As shown in Table 2, the fat and/or oil compositions for heat cooking according to Examples 1 to 5 have been confirmed to clearly reduce the amount of oil contained in the resulting fried foods compared with the oil according to Comparative Example with no addition of an emulsifying agent.

### <Test 3: Effect Verification Test on Tempura>

Fat and/or oil compositions for heat cooking including 0% by mass (no addition), 0.02% by mass, 0.04% by mass, 0.06% by mass, 0.08% by mass, and 0.1% by mass of the emulsifying agent No. 5 used in Test 2, i.e., the fatty acid monoglyceride with the trade name “Emulsy MO(M)” manufactured by Riken Vitamin Co., Ltd. (with the HLB value of 4.3, and with the fatty acid composition by mass ratio including 24% of the palmitic acid, 21% of the oleic acid, 49% of the linoleic acid, and 6% of other acids) were prepared. With the prepared fat and/or oil compositions, tempura was actually cooked to confirm the effect of reducing the amounts of the oils contained in the cooked foods.

### 1. Preparation of Samples

The emulsifying agent No. 5 was mixed into the refined rapeseed oil named “Nisshin canola oil” (manufactured by Nisshin Oillio Group, Ltd.) to constitute 0.02% by mass, 0.04% by mass, 0.06% by mass, 0.08% by mass, and 0.10% by mass in the resulting mixtures. Thus, the corresponding fat and/or oil compositions (frying oils) according to Examples 6 to 9 and Comparative Example 3 were prepared. The emulsifying agent was dissolved and added in 800 g of the canola oil that has been heated. On the other hand, a canola oil with no addition of an emulsifying agent was prepared as Comparative Example 2.

A sweet potato was cut into cylindrical pieces each having a thickness of 5 mm and a diameter of 3.4 cm to form ingredients. A batter was prepared by mixing 38 g of tempura flour named “Showa tempura flour” (manufactured by Showa Sangyo Co., Ltd.) with 62 g of iced water. The sweet potato pieces were dipped into the prepared batter to be coated with the batter.

Then, the battered sweet potato pieces, 5 pieces at a time, were dropped into each of the frying oils that has been heated to 180° C. in a pot, and were heat-cooked for 3 minutes. At that time, after 1.5 minutes from the start of the heat cooking, the sweet potato pieces in the frying oils were turned over once. After the 3 minutes of heat cooking, the fried foods were placed on a draining rack to drain oil and left for 5 minutes, and then, the fried foods were collected as measurement samples.

The number of the fried food samples used for each frying oil was 10.

### 2. Measurement of Amount of Oil

The prepared measurement samples (the fried foods) were subjected to weight measurement, followed by drying under a reduced pressure to remove water therefrom. At that time, the weights of the samples were measured before and after the samples were subjected to the drying in order to calculate the amounts of water contained therein.

Each of the dried samples was immersed in 30 mL of hexane to let the oil contained in the sample dissolve in a hexane fraction (oil extraction). The hexane fraction was collected to remove the hexane. Subsequently, the remaining oil was weighed. An average of the weight values obtained from 10 samples was calculated as the amount of oil. Furthermore, the ratio of oil was calculated by dividing the weights of the oils by the weights of the samples which have not yet been subjected to the drying. Table 3 lists the amount of oil and the ratio of oil for the samples using the frying oils.

TABLE 3

| | Added | Amount | Ratio |
|---|---|---|---|
| | amount | of oil | of oil |
| | (% by mass) | (g) | (%) |
| Comparative | 0 | 2.11 | 22.8 |
| Example 2 | | | |
| Example 6 | 0.02 | 1.86 | 20.9 |
| Example 7 | 0.04 | 1.90 | 21.4 |
| Example 8 | 0.06 | 1.82 | 20.6 |
| Example 9 | 0.08 | 1.81 | 20.7 |
| Comparative | 0.10 | 2.33 | 23.7 |
| Example 3 | | | |

As shown in Table 3, the fat and/or oil compositions for heat cooking according to Examples 6 to 9 have been confirmed to clearly reduce the amount of oil contained in the resulting fried foods compared with Comparative Example 2 with no addition of an emulsifying agent and Comparative Example 3 added with 0.10% of the emulsifying agent.

### INDUSTRIAL APPLICABILITY

A fat and/or oil composition for heat cooking according to the present invention may be used in the field of food manufacturing preferably as a frying oil used in manufacture of fried foods. A fat and/or oil composition for heat cooking according to the present invention may also be used in manufacture of any other food using a fat and/or oil for heat cooking.

1. A fat and/or oil composition for heat cooking, the fat and/or oil composition comprising:
a fat and/or oil; and
0.02 to 0.08% by mass of an emulsifying agent, wherein
the emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.

2. The fat and/or oil composition for heat cooking of claim 1, wherein the sucrose erucic acid ester has a HLB value in the range from 1.5 to 3.0.

3. A method of preparing a fat and/or oil composition for heat cooking, the method comprising the steps of:
refining a fat and/or oil; and
adding 0.02 to 0.08% by mass of an emulsifying agent into the refined fat and/or oil, wherein
the emulsifying agent is at least one selected from the group consisting of a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.
